(19) United States
(12) Patent Application Publication
(10) Pub. No.: US 2026/0005524 A1
(43) Pub. Date: Jan. 1, 2026

(54) POWER STORAGE SYSTEM AND POWER STORAGE DEVICE

(71) Applicant: TOYOTA JIDOSHA KABUSHIKI KAISHA, Toyota-shi (JP)

(72) Inventor: Manabu SASAKI, Hashima-shi (JP)

(73) Assignee: TOYOTA JIDOSHA KABUSHIKI KAISHA, Toyota-shi (JP)

(21) Appl. No.: 19/218,911

(22) Filed: May 27, 2025

(30) Foreign Application Priority Data
Jun. 28, 2024 (JP) 2024-105034

(51) Int. Cl. H02J 7/00

(52) U.S. Cl. CPC H02J 7/0014; H02J 2207/20

(57) ABSTRACT

A power storage device includes: a battery cell; a power terminal; a memory that stores information on the battery cell; and a signal terminal at which voltage and temperature signals of the battery cell and input-output data of the memory are transmitted and received. A charger includes: a signal terminal; a power output terminal to output power to the power storage device; an AC power input terminal; a DC power input terminal; a power converter that converts input power into output power; a current converter, a voltage converter, and a temperature converter that convert a current signal, a voltage signal, and a temperature signal of the battery cell into current data, voltage data, and temperature data, respectively; and an ECU that processes the data.

### CROSS REFERENCE TO RELATED APPLICATIONS

This nonprovisional application is based on Japanese Patent Application No. 2024-105034 filed on Jun. 28, 2024 with the Japan Patent Office, the entire contents of which are hereby incorporated by reference.

### BACKGROUND

### Field

The present disclosure relates to a power storage system and a power storage device, and more particularly, to a power storage system including a power storage device attachable to and detachable from a vehicle and a charger connectable to the power storage device, as well as a power storage device attachable to and detachable from a vehicle.

### Description of the Background Art

Conventionally, there has been an in-vehicle power storage system capable of controlling charging of a rechargeable battery of a vehicle so as to reduce power consumption even when a rechargeable battery module detachable from the vehicle is used (see, for example, Japanese Patent Laying-Open No. 2021-57998).

### SUMMARY

The in-vehicle power storage system of Japanese Patent Laying-Open No. 2021-57998 is configured to include a rechargeable battery controller in addition to the rechargeable battery in the rechargeable battery module. A rechargeable battery for electric power to be used for traveling mounted on a vehicle has a larger capacity and is larger than storage batteries used for other electric devices. Therefore, since the rechargeable battery module is heavy and large, it is difficult to carry the rechargeable battery module.

FIG. 6 is a diagram schematically illustrating a configuration of a conventional power storage system 9. Referring to FIG. 6, the power storage system 9 includes a power storage device 80 attachable to and detachable from a vehicle, and a charger 90 connectable to the power storage device 80. The power storage device 80 includes an electronic control unit (ECU) 810, a battery 850, a switch 830, a switch driver 831, a voltage converter 832, a temperature converter 833, a current converter 834, a current sensor 835, power terminals 841 and 842, and a signal terminal 843. The ECU 810 includes a central processing unit (CPU) 811, a memory 812, and a communication unit 813. The battery 850 includes a plurality of battery cells 851, a voltage sensor 852, and a temperature sensor 853.

The battery cell 851 is, for example, a lithium ion battery. The battery cell 851 may be a nickel-metal hydride battery or an all-solid-state battery. The battery cells 851 included in the battery 850 are connected in series. The voltage sensor 852 detects the voltage of each battery cell 851 and outputs a voltage signal indicating the detected voltage to the voltage converter 832. The voltage converter 832 converts the analog voltage signal from the voltage sensor 852 into digital voltage data, and outputs the resultant voltage data to the ECU 810. The temperature sensor 853 detects the temperature of each battery cell 851 and outputs a temperature signal indicating the detected temperature to the temperature converter 833. The temperature converter 833 converts the analog temperature signal from the temperature sensor 853 into digital temperature data, and outputs the resultant temperature data to the ECU 810. The current sensor 835 is provided on an electric wire between the battery 850 and the power terminal 842, detects a current flowing through the electric wire, and outputs a current signal indicating the detected current to the current converter 834. The current converter 834 converts the analog current signal from the current sensor 835 into digital current data, and outputs the resultant current data to the ECU 810. The switch driver 831 controls connection and disconnection of the switch 830 in accordance with a control signal from the ECU 810. The switch 830 is provided on an electric wire between the battery 850 and the power terminal 841, and is driven by the switch driver 831 to be in a connected state in which a current flows between the battery 850 and the power terminal 841, or to be in a cut-off state in which a current does not flow between the battery 850 and the power terminal 841.

The charger 90 includes an ECU 910, a power converter 950, power output terminals 941 and 942, DC power input terminals 951 and 952, AC power input terminals 961 to 963, and a signal terminal 943. The ECU 910 includes a CPU 911, a memory 912, and a communication unit 913. DC power input terminals 951 and 952 receive input of DC power from output terminals 31 and 32 of a DC power supply 30 or output terminals 71 and 72 of a solar panel 70, and output the received DC power to the power converter 950. AC power input terminals 961 to 963 receive input of AC power from output terminals 51 to 53 of an AC power supply 50, and output the received AC power to the power converter 950. The power converter 950 is controlled by the ECU 910, converts the input DC power or AC power into DC power of a charging voltage of the battery 850, and outputs the DC power to the power output terminals 941 and 942.

The power output terminals 941 and 942 and the signal terminal 943 of the charger 90 are connected to the power terminals 841 and 842 and the signal terminal 843 of the power storage device 80, respectively. The power from the power converter 950 is supplied to the battery 850 via the power output terminals 941 and 942 and the power terminals 841 and 842. The battery cell 851 of the battery 850 is charged with the supplied power. The communication unit 913 of the ECU 910 of the charger 90 and the communication unit 813 of the ECU 810 of the power storage device 80 communicate with each other via the signal terminals 943 and 843. The CPU 911 of the ECU 910 of the charger 90 processes data stored in the memory 912 or received from the communication unit 913 in accordance with a program stored in the memory 912, and controls the charger 90 by storing the processed data in the memory 912 or outputting the processed data from the communication unit 913. The CPU 811 of the ECU 810 of the power storage device 80 processes data stored in the memory 812 or received from the communication unit 813 according to a program stored in the memory 812, and controls the power storage device 80 by storing the processed data in the memory 812 or outputting the processed data from the communication unit 813.

As described above, in the conventional power storage system 9, the components other than the battery 850, such as the ECU 810, the voltage converter 832, the switch driver 831, the voltage converter 832, the temperature converter 833, and the current converter 834, are provided on the power storage device 80 side. Therefore, in the case where the power storage system 9 is mounted on a vehicle, if the power storage device 80 is configured to be attachable to and detachable from the vehicle, since the capacity and weight of a portion other than the battery 850 are included in the power storage device 80, the power storage device 80 becomes large and heavy, and it becomes difficult to carry the power storage device 80.

Further, in order to facilitate attachment and detachment of the power storage device 80 to and from the vehicle, it is conceivable to provide a plurality of power storage devices 80 mounted on the vehicle and reduce the amount of power stored per power storage device 80 to reduce the volume and weight of the power storage device 80. In this way, the ratio of the volume and weight of the portion other than the battery 850 to the volume and weight of the plurality of power storage devices 80 mounted on the vehicle is further increased.

The present disclosure has been made to solve the above-described problems, and an object thereof is to provide a power storage system and a power storage device that facilitates carriage of the power storage device.

A power storage system according to the present disclosure is a power storage system including: a power storage device attachable to and detachable from a vehicle; and a charger connectable to the power storage device. The power storage device includes: at least one battery cell; a first power terminal at which power to and from the battery cell is input and output; a memory that stores information on the battery cell; and a first signal terminal at which a voltage signal in analog form representing a voltage of the battery cell, a temperature signal in analog form representing a temperature of the battery cell, and input-output data of the memory are transmitted to and received from the charger. The charger includes: a second signal terminal at which the voltage signal, the temperature signal, and the input-output data are transmitted to and received from the power storage device; a second power terminal at which power is output to the power storage device; a third power terminal at which power from a power supply is input; a power converter that converts power input from the third power terminal into power to be output from the second power terminal; a current converter that converts a current signal in analog form representing current flowing through the battery cell into current data in digital form; a voltage converter that converts the voltage signal into voltage data in digital form; a temperature converter that converts the temperature signal into temperature data in digital form; and an electronic control unit that processes the current data, the voltage data, and the temperature data.

In the configuration as described above, the electronic control unit for controlling the power storage device is included in the charger. The power storage device can be reduced in weight and size, as compared with a power storage device including the electronic control unit. Accordingly, the power storage system having the power storage device that is carried easily can be provided.

A plurality of the power storage devices may be connectable to the charger. In the configuration as described above, the ratio of the volume and weight of the portion other than the battery cells of a combination of a plurality of power storage devices, to the total volume and weight of the combination thereof, can further be reduced, as compared with the case where a plurality of power storage devices include respective electronic control units.

The electronic control unit may control the power converter so as to cause the power storage device to be charged, using the information on the battery cell indicated by the input-output data. In the configuration as described above, charging of the power storage device can be controlled appropriately by using the information on each battery cell of the power storage device, even when the electronic control unit controlling the power storage device is included in the charger.

According to another aspect of the present disclosure, a power storage device is a power storage device attachable to and detachable from a vehicle, and includes: at least one battery cell; a power terminal at which power to and from the battery cell is input and output; a memory that stores information on the battery cell; and a signal terminal at which a voltage signal in analog form representing a voltage of the battery cell, a temperature signal in analog form representing a temperature of the battery cell, and input-output data of the memory are transmitted to and received from a charger. With the configuration as described above, the power storage device that is carried easily can be provided.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a diagram schematically illustrating a configuration of a power storage system according to a first embodiment.

FIG. 2 is a diagram schematically illustrating a configuration of a power storage system according to a second embodiment.

FIG. 3 is a diagram schematically illustrating a configuration of a power storage system according to a third embodiment.

FIG. 4 is a diagram schematically illustrating a configuration of a power storage system according to a fourth embodiment.

FIG. 5 is a diagram schematically illustrating a configuration of a power storage system according to a fifth embodiment.

FIG. 6 is a diagram schematically illustrating a configuration of a conventional power storage system.

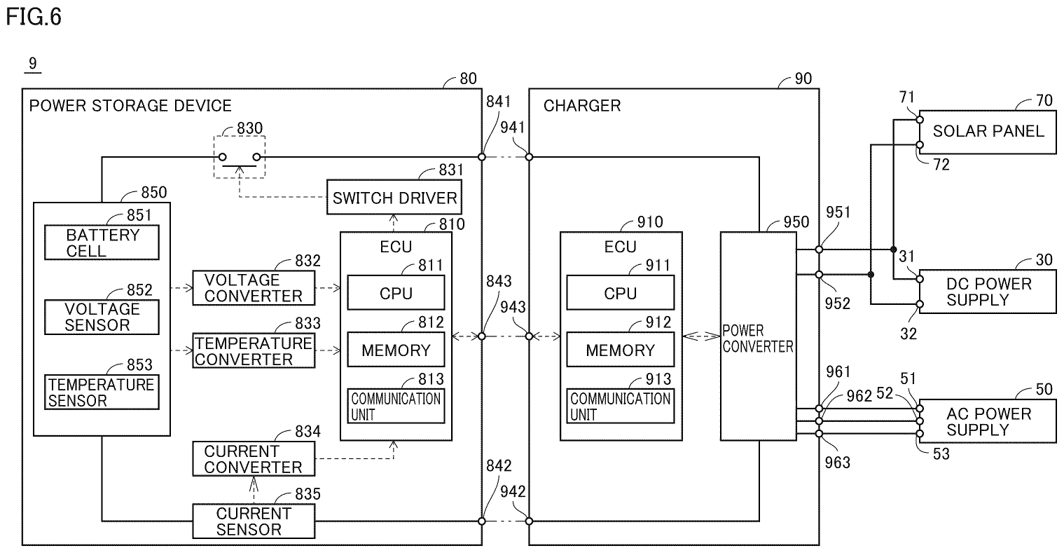

### DESCRIPTION OF THE PREFERRED EMBODIMENTS

Hereinafter, embodiments of the present disclosure will be described in detail with reference to the drawings. In the drawings, the same or corresponding parts are denoted by the same reference numerals, and the description thereof will not be repeated.

### First Embodiment

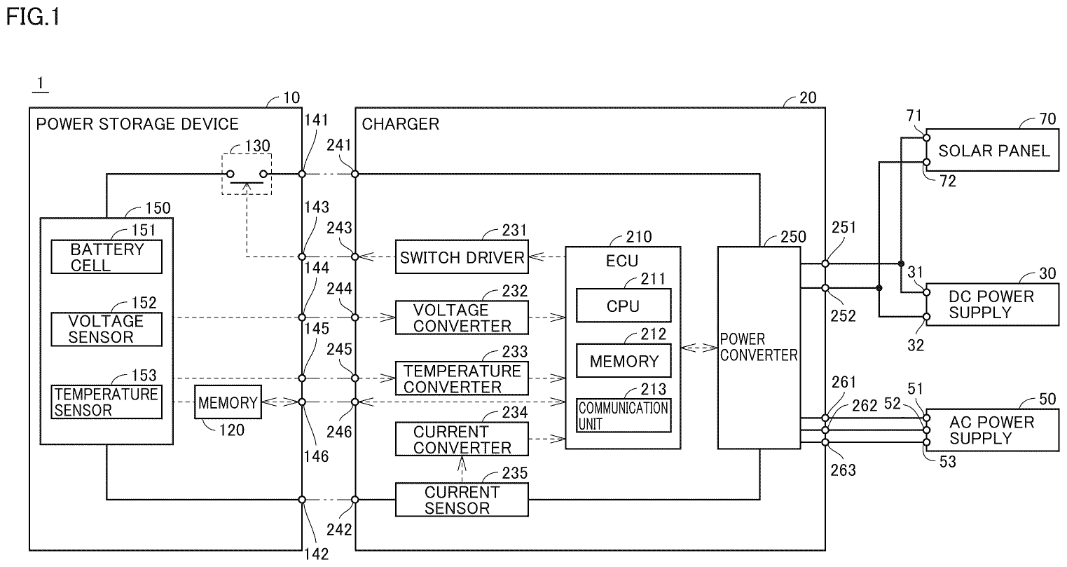

FIG. 1 is a diagram schematically illustrating a configuration of a power storage system 1 according to a first embodiment. Referring to FIG. 1, the power storage system 1 includes a power storage device 10 attachable to and detachable from a vehicle, and a charger 20 connectable to the power storage device 10. The charger 20 includes an ECU 210, a power converter 250, a switch driver 231, a voltage converter 232, a temperature converter 233, a current converter 234, a current sensor 235, power output terminals 241 and 242, DC power input terminals 251 and 252, AC power input terminals 261 to 263, and signal terminals 243 to 246. The ECU 210 includes a CPU 211, a memory 212, and a communication unit 213.

The power storage device 10 includes a battery 150, a switch 130, a memory 120, power terminals 141 and 142, and signal terminals 143 to 146. The battery 150 includes a plurality of battery cells 151, a voltage sensor 152, and a temperature sensor 153. The battery cell 151 is, for example, a lithium ion battery. The battery cell 151 may be a nickel-metal hydride battery or an all-solid-state battery. The battery cells 151 included in the battery 150 are connected in series.

The power output terminals 241 and 242 and the signal terminals 243 to 246 of the charger 20 are connected to the power terminals 141 and 142 and the signal terminals 143 to 146 of the power storage device 10, respectively. In this embodiment, one power output terminal 241, one power terminal 141, and one DC power input terminal 251 are positive terminals, and the other power output terminal 242, the other power terminal 142, and the other DC power input terminal 252 are negative terminals, however, the positive terminals may be negative terminals, and the negative terminals may be positive terminals.

DC power input terminals 251 and 252 receive input of DC power from output terminals 31 and 32 of a DC power supply 30 or output terminals 71 and 72 of a solar panel 70, and output the received DC power to the power converter 250. AC power input terminals 261 to 263 receive AC power from output terminals 51 to 53 of an AC power supply 50, and output the received AC power to the power converter 250. The AC power input terminals 261 to 263 are U-phase, V-phase, and W-phase terminals of three-phase AC, respectively. The output terminals 51 to 53 are U-phase, V-phase, and W-phase terminals of three-phase AC, respectively. Instead of the three-phase alternating current, a single-phase alternating current may be used. The power converter 250 is controlled by the ECU 210, converts the input DC power or AC power into DC power of the charging voltage of the battery 150, and outputs the DC power to the power output terminals 241 and 242. The power from the power converter 250 is supplied to the battery 150 via the power output terminals 241 and 242 and the power terminals 141 and 142. The battery cell 151 of the battery 150 is charged by the supplied power.

The voltage sensor 152 detects the voltage of each battery cell 151, and outputs a voltage signal indicating the detected voltage to the voltage converter 232 via the signal terminals 144 and 244. The voltage converter 232 converts the analog voltage signal from the voltage sensor 152 into digital voltage data, and outputs the resultant voltage data to the ECU 210. The temperature sensor 153 detects the temperature of each battery cell 151 and outputs a temperature signal indicating the detected temperature to the temperature converter 233 via the signal terminals 145 and 245. The temperature converter 233 converts the analog temperature signal from the temperature sensor 153 into digital temperature data, and outputs the resultant temperature data to the ECU 210. The current sensor 235 is provided on an electric wire between the power output terminal 242 and the power converter 250, detects a current flowing through the electric wire, and outputs a current signal indicating the detected current to the current converter 234. The current converter 234 converts the analog current signal from the current sensor 235 into digital current data, and outputs the resultant current data to the ECU 210. The switch driver 231 controls connection and disconnection of the switch 130 in accordance with a control signal from the ECU 210. The switch 130 is provided on an electric wire between the battery 150 and the power terminal 141. The switch 130 is driven by the switch driver 231 to be in a connected state in which a current flows between the battery 150 and the power terminal 141 or in a cut-off state in which a current does not flow between the battery 150 and the power terminal 141.

The communication unit 213 of the ECU 210 of the charger 20 and the memory 120 of the power storage device 10 communicate with each other via the signal terminals 246 and 146. The CPU 211 of the ECU 210 of the charger 20 processes data stored in the memory 212, received from the communication unit 913, or received from the memory 120 according to a program stored in the memory 212, and controls the charger 20 and the power storage device 10 by storing the processed data in the memory 912, outputting the processed data from the communication unit 913, or transmitting the processed data to the memory 120.

The memory 120 may store an open circuit voltage (OCV) of each battery cell 151 before charging or discharging, and may record a difference ΔV between the OCV and a closed circuit voltage (CCV) during energization for each battery cell 151. The measured internal resistance of each battery cell 151 may be stored in the memory 120. The memory 120 may store the number of times of charging, the number of times of full charging, the full charge capacity of each battery cell 151, the drop amount of the internal resistance of each battery cell 151, or the past abnormality detection history. Accordingly, the ECU 210 of the charger 20 can detect a potential abnormality of the battery cell 151 and appropriately execute the charging control by using the data stored in the memory 120.

The CPU 211 of the ECU 210 may integrate the charging current using the current from the current converter 234, or may integrate the charging power using the current and the voltage from voltage converter 232. The CPU 211 of the ECU 210 may sequentially estimate the power storage amount of each battery cell 151 from the integrated value of the energization current of the battery cell 151 and the change width of the OCV, and sequentially store the estimated power storage amount in the memory 120. Thus, the current state of charge (SOC) of the battery 150 can be estimated.

The CPU 211 of the ECU 210 of the charger 20 may measure and record the OCV of each battery cell 151 before starting the charging of the power storage device 10, grasp the full charge capacity and the variation in the full charge capacity of each battery cell 151 from the change in the charging power amount from the start of the charging to the stop of the charging and the OCV at the time of the stop of the charging, and store them in the memory 120 of the power storage device 10.

In addition, the history of the temperature change of each battery cell 151 may be stored in the memory 120. Accordingly, the CPU 211 of the ECU 210 can grasp the history of the temperature distribution for each battery cell 151 using the data of the memory 120. When the charger 20 and the power storage device 10 are used in a use environment other than a vehicle, the temperature distribution of the battery cells 151 may be uneven depending on the use environment. For example, in a case where the power storage device 10 is charged by using the charger 20 near a fire, only one side of the power storage device 10 is heated by the fire. As described above, even when the temperatures of the battery cells 151 are partially different, the history of the temperature distribution of each battery cell 151 can be grasped.

In addition, the memory 120 may store information indicating that charging of the battery 150 is prohibited. When the memory 120 stores information indicating that charging of the battery 150 is prohibited, the ECU 210 controls the switch driver 231 to bring the switch 130 into the cut-off state, thereby preventing charging.

As described above, since the power storage device 10 includes the memory 120, the charger 20 can execute the charging control according to the state of the battery cell 151. In addition, a device (for example, a device that uses electric power of the power storage device 10, or a device that charges and discharges electric power such as an inverter that controls a motor) different from the charger 20 to which the power storage device 10 is connected may control charging and discharging of power using information stored in the memory 120 of the power storage device 10.

The power storage device 10 may have a function of equalizing the cell voltages of the plurality of battery cells 151, or may have a function of equalizing and discharging the plurality of battery cells 151 in consideration of variations in the cell voltages OCV and the full charge capacity. The power storage system 1 may include a power storage device inside the charger 20 and have a function of moving equalized discharge power of a certain battery cell 151 to another battery cell 151 having a low voltage via the power storage device. Thus, the variation in the charging power of the battery cell 151 can be made uniform, and the output power of the power storage device 10 can be maximized. When the equalized discharge power is moved to the low-voltage battery cell 151, there is a concern that the power storage device 10 becomes larger and the equalization time becomes longer due to the power storage device for equalization, but by mounting the power storage device on the charger 20 side, the circuit including the power storage device for equalization can be easily increased in size, and the time required for equalization can be shortened by increasing the size of the circuit for equalization.

The CPU 211 of the ECU 210 may use information on whether or not there is a household solar cell such as the solar panel 70, whether or not it is a preferred purchasing period of photovoltaic power generation in a Feed-in-Tariff (FIT) system, a purchasing rate of photovoltaic power generation, a power amount rate from a power company, information from HEMS (Home Energy Management System) (for example, an excess power state of photovoltaic power generation and a past power generation history), information (for example, a weather forecast) acquired by a net connection using an Internet of Things (IOT) function or the like, or transition of power consumption depending on season and time zone in a place (for example, a home, a vehicle, or the like) where the power storage system 1 is provided, to perform the following. For example, the CPU 211 may compare the photovoltaic power generation surplus power with the photovoltaic power generation power trade unit price, and determine the charging timing so that the power fee until the battery 150 is fully charged becomes the optimum economic power fee. The CPU 211 may determine the charging timing in consideration of the estimation of the generated surplus power from the weather forecast up to the charging completion time. The CPU 211 may perform charge completion time management involving management of charging power that can be expected to be highly economical for an unspecified power storage device 10. When the specification and structure of the home power supply allow, the CPU 211 may control charging so as to realize the optimum economic power fee of the home power fee by supplying the stored power of the power storage device 10 to the home power supply. In a case where the timer time management of the power storage device 10 is set to a relatively long charge time such as “the next use is not scheduled” or “the use is scheduled after one week”, the power storage device 10 may be caused to function as a home power storage device. The power storage device 10 may be used as a backup power supply for home power or a power storage device for nighttime use of surplus generated power of home power for which the FIT period has ended.

### Second Embodiment

In the first embodiment, a case where one power storage device 10 is provided in the power storage system 1 has been described. In the second embodiment, a case where a plurality of power storage devices 10 are provided in the power storage system 1A will be described.

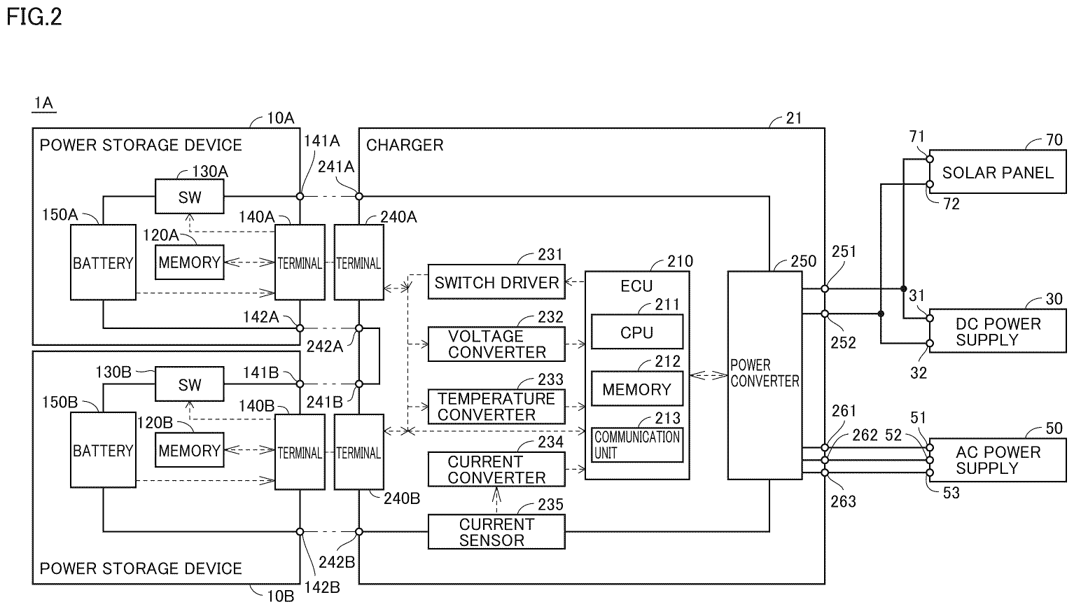

FIG. 2 is a diagram schematically illustrating a configuration of a power storage system 1A according to the second embodiment. Referring to FIG. 2, in the second embodiment, differences from the first embodiment will be described, and redundant description will not be repeated.

The charger 21 includes a plurality of power output terminals 241A and 242A and power output terminals 241B and 242B in place of the power output terminals 241 and 242 of the charger 20 of the first embodiment. The signal terminals 240A and 240B include terminals similar to the signal terminals 243 to 246, respectively. The signal terminals 140A and 140B include terminals similar to the signal terminals 143 to 146, respectively. The power storage devices 10A and 10B have the same configuration as the power storage device 10 of the first embodiment. The batteries 150A and 150B, the memories 120A and 120B, the switches 130A and 130B, the positive power terminals 141A and 141B, and the negative power terminals 142A and 142B are the same as the battery 150, the memory 120, the switch 130, the positive power terminal 141, and the negative power terminal 142 of the power storage device 10 of the first embodiment, respectively.

The power output terminal 242A and the power output terminal 241B are directly connected by an electric wire. As a result, the batteries 150A and 150B are connected in series to the charger 21. As a result, when the number of power storage devices 10A and 10B connected to charger 21 is N (N=2 in this embodiment), the voltage between power terminals 141A and 142A and the voltage between power terminals 141B and 142B can be set to 1/N of the voltage required in the vehicle output from power converter 250. In this manner, the voltage between the power terminals 141A and 142A and the voltage between the power terminals 141B and 142B of the power storage devices 10A and 10B that are carried can be set to a voltage of 1/N lower than the voltage required in the vehicle. As a result, the power storage devices 10A and 10B can be carried at a relatively low voltage.

In addition, by setting the voltage between the power terminals 141A and 142A and the voltage between the power terminals 141B and 142B of the power storage devices 10A and 10B to be a common divisor of a voltage used in a vehicle and a voltage used in a device other than a vehicle, the power storage devices 10A and 10B can be flexibly used not only in a vehicle but also in a device other than a vehicle. For example, when the voltage used in the vehicle is 360 V and the voltage used in the devices other than the vehicle is 24 V, by setting the voltage between the power terminals 141A and 142A of the power storage devices 10A and 10B and the voltage between the power terminals 141B and 142B to 12 V, which is a common divisor, 24/12=2 power storage devices 10A and 10B can be used in series in the devices other than the vehicle, and 360/12=30 power storage devices 10A and 10B can be used in series in the vehicle. In addition, the number of series-connected battery cells 151 inside the batteries 150A and 150B can be easily varied.

In the case of operating a necessary number or more of power storage devices 10A and 10B in which spare power storage devices 10A and 10B are prepared in advance, VE (Value Engineering) can be contributed by not providing the ECU, the switch driver 231, the voltage converter 232, the temperature converter 233, and the current converter 234 in the power storage devices 10A and 10B.

In addition, since a plurality of power storage devices 10A and 10B are used in combination, it is assumed that the degradation states of the batteries 150A and 150B vary. Therefore, identification information (for example, ID numbers) for identifying the power storage devices 10A and 10B may be assigned to the memories 120A and 120B. The battery state for each identification information of the power storage devices 10A and 10B may be stored in the memory 212 of the ECU 210 of the charger 21, or may be transmitted from the communication unit 213 of the ECU 210 of the charger 21 to an external server and managed by the server. Thus, the battery states of the plurality of power storage devices 10A and 10B can be managed.

### Third Embodiment

In the second embodiment, the plurality of power storage devices 10A and 10B are connected in series when connected to the charger 21. In the third embodiment, the plurality of power storage devices 10A and 10B are connected in parallel when they are connected to the charger 22.

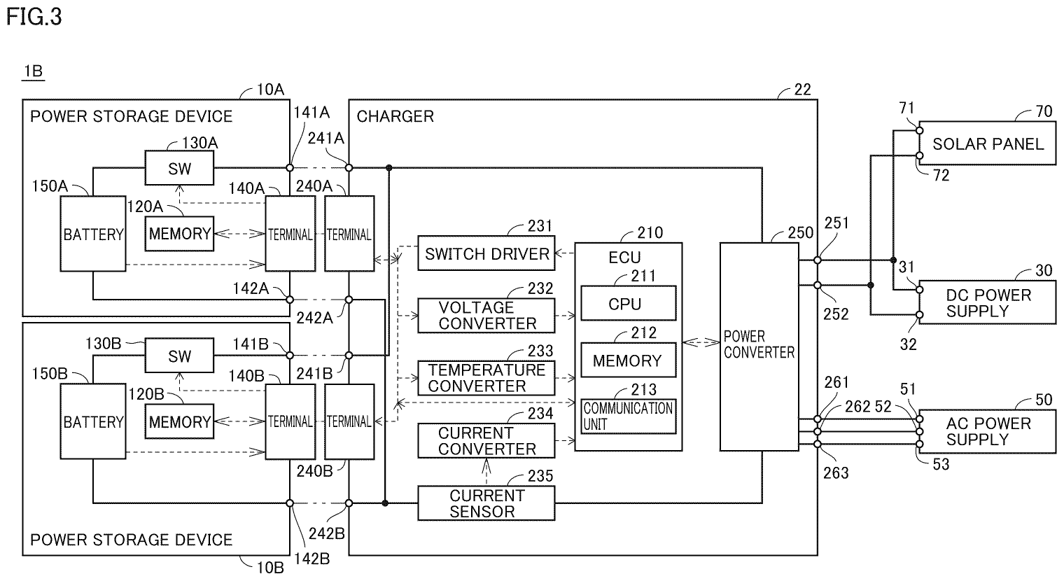

FIG. 3 is a diagram schematically illustrating a configuration of a power storage system 1B according to the third embodiment. Referring to FIG. 3, in the third embodiment, differences from the second embodiment will be described, and redundant description will not be repeated.

The power output terminals 241A and 241B are directly connected by an electric wire. The power output terminals 242A and 242B are directly connected by an electric wire. As a result, the power storage devices 10A and 10B are connected in parallel to the charger 22. As a result, the plurality of power storage devices 10A and 10B can be charged with the output voltage of the power converter 250 in parallel.

### Fourth Embodiment

In the second embodiment, the switches 130A and 130B are provided in the power storage devices 10A and 10B. In the fourth embodiment, the switch 230 is provided in the charger 23.

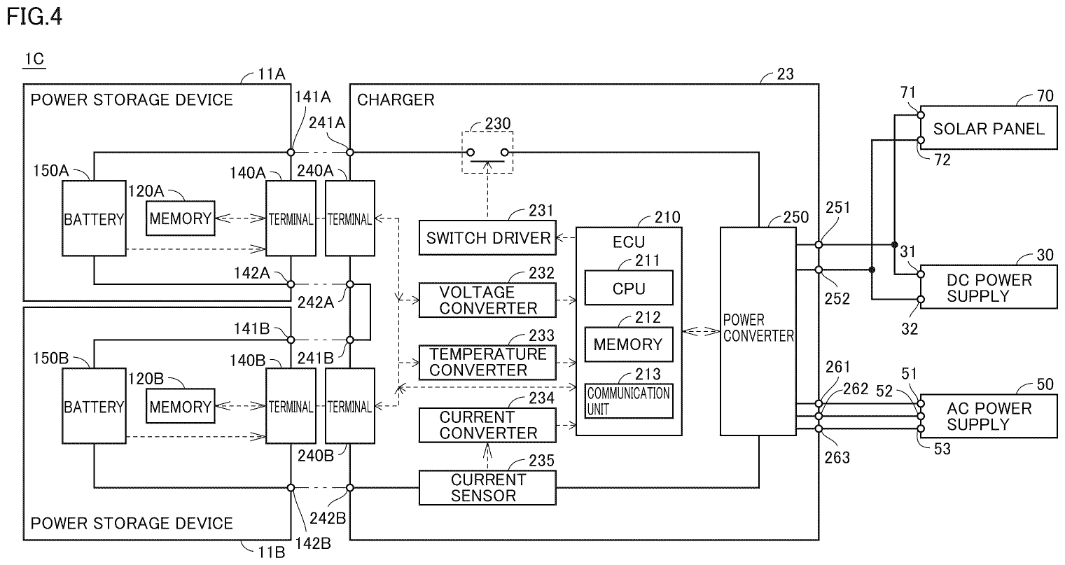

FIG. 4 is a diagram schematically illustrating a configuration of a power storage system 1C according to the fourth embodiment. Referring to FIG. 4, in the fourth embodiment, differences from the second embodiment will be described, and redundant description will not be repeated.

In the second embodiment, the power storage devices 10A and 10B include switches 130A and 130B, respectively. In the fourth embodiment, as shown in FIG. 4, the power storage devices 11A and 11B do not include switches.

On the other hand, in the second embodiment, the charger 21 does not include a configuration such as the switch 130. In the fourth embodiment, as illustrated in FIG. 4, the charger 22 further includes a switch 230. The switch 230 is provided on an electric wire between the power converter 250 and the power output terminal 241A.

The switch 230 is driven by the switch driver 231 to be in a connected state in which a current flows between the power converter 250 and the power output terminal 241A, or in a cut-off state in which a current does not flow between the power converter 250 and the power output terminal 241A.

Thus, in the second embodiment, a plurality of switches 130A and 130B are required in the power storage system 1A, whereas in the fourth embodiment, only one switch 230 is required in the power storage system 1C. As a result, in the power storage system 1C, the cost for providing the switch can be reduced.

### Fifth Embodiment

In the third embodiment, the switches 130A and 130B are provided in the power storage devices 10A and 10B. In the fifth embodiment, the switch 230 is provided in the charger 24.

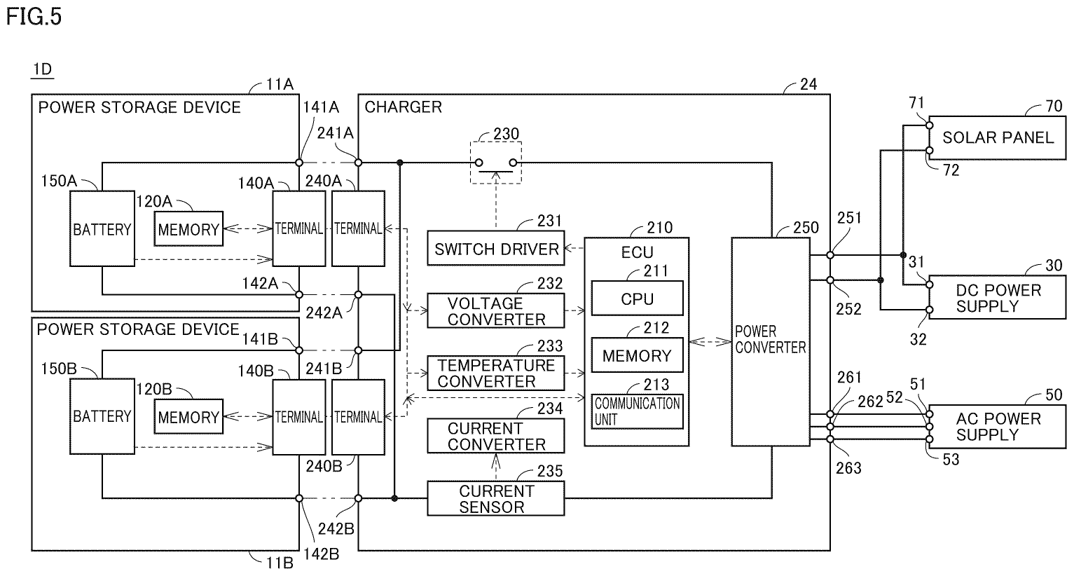

FIG. 5 is a diagram schematically illustrating a configuration of a power storage system 1D according to the fifth embodiment. With reference to FIG. 5, in the fifth embodiment, differences from the third embodiment will be described, and redundant description will not be repeated.

In the third embodiment, the power storage devices 10A and 10B include switches 130A and 130B, respectively. In the fifth embodiment, as shown in FIG. 5, the power storage devices 11A and 11B do not include switches.

On the other hand, in the third embodiment, the charger 22 does not include a configuration such as the switch 130. In the fifth embodiment, as shown in FIG. 5, the charger 24 further includes a switch 230. The switch 230 is provided on a wire between the power converter 250 and the power output terminal 241A. The switch 230 is driven by the switch driver 231 to be in a connected state in which a current flows between the power converter 250 and the power output terminal 241A, or in a cut-off state in which a current does not flow between the power converter 250 and the power output terminal 241A.

Thus, in the third embodiment, a plurality of switches 130A and 130B are required in the power storage system 1B, whereas in the fifth embodiment, only one switch 230 is required in the power storage system 1D. As a result, in the power storage system 1D, the cost for providing the switch can be reduced.

### Other Modifications

(1) As shown in FIGS. 1 to 5, the power storage device 10, 10A, 10B, 11A, 11B is attachable to and detachable from the vehicle, and the charger 20-24 is not mounted on the vehicle. However, the present disclosure is not limited thereto, and the charger 20-24 may be configured to be mounted on a vehicle.
(2) In the above-described embodiment, the battery cells 151 of the battery 150 are connected in series. However, the present disclosure is not limited thereto, and the battery cells 151 may be connected in parallel, or may be connected in combination of series and parallel.
(3) In the above-described embodiment, as illustrated in FIGS. 1 to 5, the power converter 250 can receive the DC power and the AC power. However, the present disclosure is not limited thereto, and the power converter 250 may be configured to be capable of receiving input of either DC power or AC power.
(4) The above disclosure can be considered as disclosure of the power storage systems 1 and 1A to 1D, the power storage devices 10, 10A, 10B, 11A, and 11B, or the chargers 20 to 24, and can be considered as disclosure of the power storage method by the power storage systems 1 and 1A to 1D, the power storage devices 10, 10A, 10B, 11A, and 11B, or the chargers 20 to 24.

### SUMMARY

(10 As illustrated in FIGS. 1 to 5, the power storage system 1, 1A-1D includes the power storage device 10, 10A, 10B, 11A, 11B attachable to and detachable from a vehicle, and the charger 20-24 connectable to the power storage device 10, 10A, 10B, 11A, 11B. As illustrated in FIGS. 1 to 5, the power storage device 10, 10A, 10B, 11A, 11B includes at least one battery cell 151, a first power terminal (for example, power terminals 141, 142, 141A, 142A, 141B, 142B) at which power (for example, DC power of a predetermined voltage) to and from the battery cell 151 is input and output, the memory 120, 120A, 120B that stores information on the battery cell 151, a first signal terminal (for example, signal terminals 143 to 146, 140A, 140B) at which a voltage signal in analog form representing a voltage of the battery cell 151, a temperature signal in analog form representing a temperature of the battery cell 151, and input-output data of the memory 120, 120A, 120B are transmitted to and received from the charger 20-24.

As illustrated in FIGS. 1 to 5, the charger 20-24 includes a second signal terminal (for example, signal terminals 243 to 246, 240A, 240B) at which the voltage signal, the temperature signal, and the input-output data are transmitted to and received from the power storage device 10, 10A, 10B, 11A, 11B, a second power terminal (for example, power output terminals 241, 242, 241A, 242A, 241B, 242B) at which power is output to the power storage device 10, 10A, 10B, 11A, 11B, a third power terminal (for example, AC power input terminals 261 to 263, DC power input terminals 251, 252) at which power from a power supply (for example, AC power supply 50, DC power supply 30, solar panel 70) is input, the power converter 250 that converts power input from the third power terminal (for example, AC power or DC voltage of a predetermined input voltage) into power to be output from the second power terminal (for example, DC power of a charging voltage of the battery 150), a current converter 234 that converts a current signal in analog form representing current flowing through the battery cell 151 into current data in digital form, the voltage converter 232 that converts the voltage signal into voltage data in digital form, the temperature converter 233 that converts the temperature signal into temperature data in digital form, and the ECU 210 that processes the current data, the voltage data, and the temperature data.

Thus, the ECU 210 for controlling the power storage device 10, 10A, 10B, 11A, 11B is included in the charger 20-24. As compared with the case where the ECU 210 is included in the power storage device 10, 10A, 10B, 11A, 11B, the power storage device 10, 10A, 10B, 11A, 11B can be reduced in weight and size. As a result, the power storage device 10, 10A, 10B, 11A, 11B can be easily carried.

In addition, the state of each power storage device can be managed with a minimum configuration and manufacturing cost by the memory 120, 120A, 120B. In addition, as compared with the case where the switch driver 231, the voltage converter 232, the temperature converter 233, or the current converter 234, which is relatively expensive, is provided on the power storage device 10, 10A, 10B, 11A, 11B side, since these configurations are provided on the charger 20-24 side, even when a large number of power storage devices 10, 10A, 10B, 11A, 11B are possessed, it is possible to reduce the cost and to eliminate waste of the usage rate of these configurations. Moreover, the power storage device 10 can be used for a variety of purposes such as a vehicle and another electric device; however, cost can be reduced, which makes it easy to additionally purchase the power storage device 10, 10A, 10B, 11A, 11B or replace the degraded power storage device 10, 10A, 10B, 11A, 11B.

In addition, in a case where the configuration of the switch driver 231, the voltage converter 232, the temperature converter 233, or the current converter 234 is provided on the charger 20 to 24 side, if the memory 120 is not provided on the power storage device 10, 10A, 10B, 11A, 11B side, the information stored in the memory 120 must be stored on the charger 20-24 side. Therefore, the charger 20-24 needs to be in a one-to-one relationship with respect to the power storage device 10, 10A, 10B, 11A, 11B. However, since the memory 120 is provided on the power storage device 10, 10A, 10B, 11A, 11B side, the power storage device 10, 10A, 10B, 11A, 11B can also be charged by the other charger 20-24 even when the configuration of the switch driver 231, the voltage converter 232, the temperature converter 233, or the current converter 234 is provided on the charger 20-24 side.
(2) As illustrated in FIGS. 2 to 5, a plurality of power storage devices may be connectable to the charger 20-24. Accordingly, as compared with the case where each of a plurality of power storage devices 10A, 10B, 11A, 11B includes the ECU 210, the ratio of the volume and weight of the portion other than the battery cell 151 to the combined volume and weight of the plurality of power storage devices 10A, 10B, 11A, 11B can be further reduced.
(3) As illustrated in FIGS. 1 to 5, the ECU 210 may control the power converter 250 so as to cause the power storage device 10, 10A, 10B, 11A, 11B to be charged, using the information on the battery cell 151 indicated by the input-output data. Accordingly, even in a case where the ECU 210 that controls the power storage device 10, 10A, 10B, 11A, 11B is provided in the charger 20-24, it is possible to appropriately control charging of the power storage device 10, 10A, 10B, 11A, 11B using the information related to each battery cell 151 of battery cells 151 of the power storage device 10, 10A, 10B, 11A, 11B.

Although the present disclosure has been described and illustrated in detail, it is clearly understood that the same is by way of illustration and example only and is not to be taken by way of limitation, the scope of the present disclosure being interpreted by the terms of the appended claims.

What is claimed is:

1. A power storage system comprising: a power storage device attachable to and detachable from a vehicle; and a charger connectable to the power storage device,
the power storage device comprising:
at least one battery cell;
a first power terminal at which power to and from the battery cell is input and output;
a memory that stores information on the battery cell; and
a first signal terminal at which a voltage signal in analog form representing a voltage of the battery cell, a temperature signal in analog form representing a temperature of the battery cell, and input-output data of the memory are transmitted to and received from the charger, and
the charger comprising:
a second signal terminal at which the voltage signal, the temperature signal, and the input-output data are transmitted to and received from the power storage device;
a second power terminal at which power is output to the power storage device;
a third power terminal at which power from a power supply is input;
a power converter that converts power input from the third power terminal into power to be output from the second power terminal;
a current converter that converts a current signal in analog form representing current flowing through the battery cell into current data in digital form;
a voltage converter that converts the voltage signal into voltage data in digital form;
a temperature converter that converts the temperature signal into temperature data in digital form; and
an electronic control unit that processes the current data, the voltage data, and the temperature data.

2. The power storage system according to claim 1, wherein a plurality of the power storage devices are connectable to the charger.

3. The power storage system according to claim 1, wherein the electronic control unit controls the power converter so as to cause the power storage device to be charged, using the information on the battery cell indicated by the input-output data.

4. A power storage device attachable to and detachable from a vehicle, the power storage device comprising:
at least one battery cell;
a power terminal at which power to and from the battery cell is input and output;
a memory that stores information on the battery cell; and
a signal terminal at which a voltage signal in analog form representing a voltage of the battery cell, a temperature signal in analog form representing a temperature of the battery cell, and input-output data of the memory are transmitted to and received from a charger.
